(19) United States
(12) Patent Application Publication
(10) Pub. No.: US 2026/0371282 A1
(43) Pub. Date: Nov. 19, 2026

(54) SYSTEMS AND METHODS FOR UTILIZING PROTOCOL CONFIGURATION OPTIONS CONTAINER CONTENT FOR USER EQUIPMENT ACTIVATION

(71) Applicant: Verizon Patent and Licensing Inc., Basking Ridge, NJ (US)

(72) Inventors: Zhengfang CHEN, Millburn, NJ (US); Andrew E. YOUTZ, Princeton, NJ (US); Axel HALLO DE WOLF, Whippany, NJ (US); Lixia YAN, Basking Ridge, NJ (US)

(73) Assignee: Verizon Patent and Licensing Inc., Basking Ridge, NJ (US)

(21) Appl. No.: 19/206,577

(22) Filed: May 13, 2025

(51) Int. Cl. H04W 60/04; H04W 8/20; H04W 8/26

(52) U.S. Cl. CPC H04W 60/04; H04W 8/20; H04W 8/265

(57) ABSTRACT

A user equipment may provide a request to attach to a network, and may receive, from the network, a protocol configuration options (PCO) container that includes a mobile station international subscriber directory number (MSISDN). The user equipment may determine whether the MSISDN includes a predefined prefix indicative of a subscription status associated with self-activation. The user equipment may selectively initiate a power-on-activation flow based on determining that the MSISDN includes the predefined prefix, or bypass the power-on-activation flow based on determining that the MSISDN does not include the predefined prefix.

### BACKGROUND

Networks may utilize various communication protocols to enable interactions between network infrastructure and connected user equipments (UEs). These protocols support the exchange of information necessary for operation of network services.

### BRIEF DESCRIPTION OF THE DRAWINGS

FIGS. 1A-1D are diagrams of an example associated with utilizing protocol configuration option (PCO) container content for UE activation.

FIG. 2 is a diagram of an example environment in which systems and/or methods described herein may be implemented.

FIG. 3 is a diagram of example components of one or more devices of FIG. 2.

FIG. 4 is a flowchart of an example process for utilizing PCO container content for UE activation.

### DETAILED DESCRIPTION OF EXAMPLE EMBODIMENTS

The following detailed description of example implementations refers to the accompanying drawings. The same reference numbers in different drawings may identify the same or similar elements.

Telecommunications networks facilitate various processes such as device activation, subscription management, and service provisioning through standardized signaling protocols. These protocols often include PCO messages, which serve as a mechanism for communicating instructions between the network and a UE. PCO messages may include operator-reserved PCO containers, identified by unique identifiers, which hold information guiding UE behavior during operations like subscriber identity module (SIM) activation and service access. However, one or more of such operator-reserved PCO containers are decommissioned at times. Thus, current techniques for handling UE activation consume computing resources (e.g., processing resources, memory resources, communication resources, and/or the like), networking resources, and/or other resources associated with failing to provide a mechanism that guides UE behavior during SIM activation, failing to provide a mechanism that provides UE and SIM self-activation, providing a poor user experience associated with UE activation, and/or the like.

Some implementations described herein relate to utilizing PCO container content for UE activation. For example, a UE may provide a request to attach to a network, and may receive, from the network, a PCO container that includes a mobile station international subscriber directory number (MSISDN). The UE may determine whether the MSISDN includes a predefined prefix indicative of a subscription status associated with self-activation. The UE may selectively initiate a power-on-activation flow based on determining that the MSISDN includes the predefined prefix, or bypass the power-on-activation flow based on determining that the MSISDN does not include the predefined prefix.

In this way, implementations described herein utilize PCO container content for UE activation. For example, the implementations may transition from operator-reserved PCO containers, which may be decommissioned, to a standardized PCO container. The standardized PCO container may include MSISDN prefixes to indicate subscription statuses and to minimize network resource consumption during subscription management processes. By reducing the network impact and optimizing the activation flow, the implementations may prevent inefficient subscription handling, redundant activation attempts, and the use of non-standardized container formats. Thus, the implementations may conserve computing resources, networking resources, and/or other resources that would have otherwise been consumed by failing to provide a mechanism that guides UE behavior during SIM activation, failing to provide a mechanism that provides UE and SIM self-activation, providing a poor user experience associated with UE activation, and/or the like.

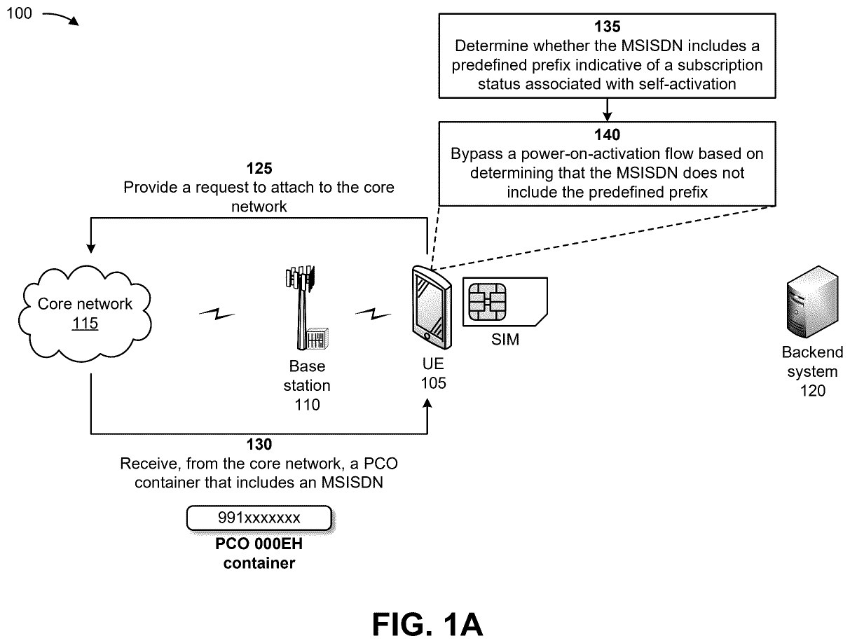

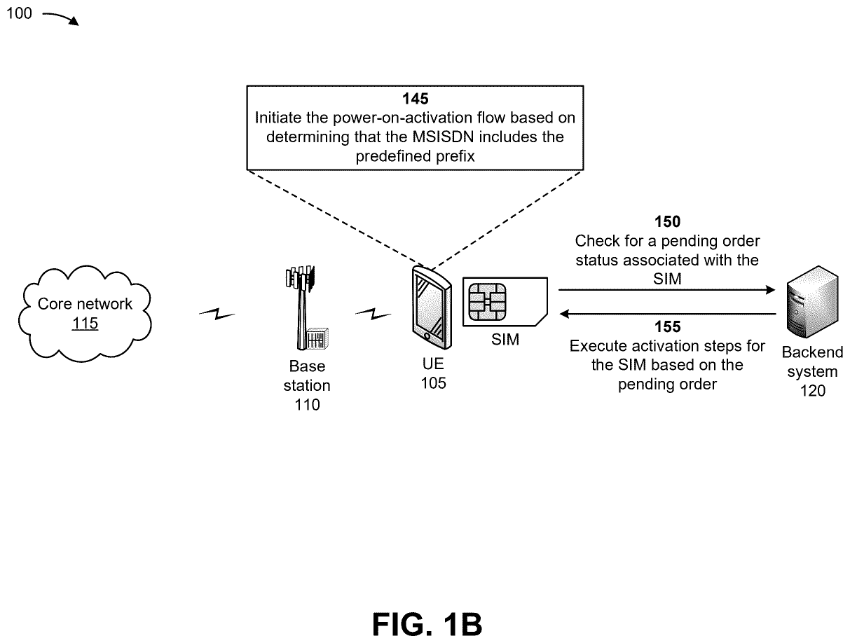

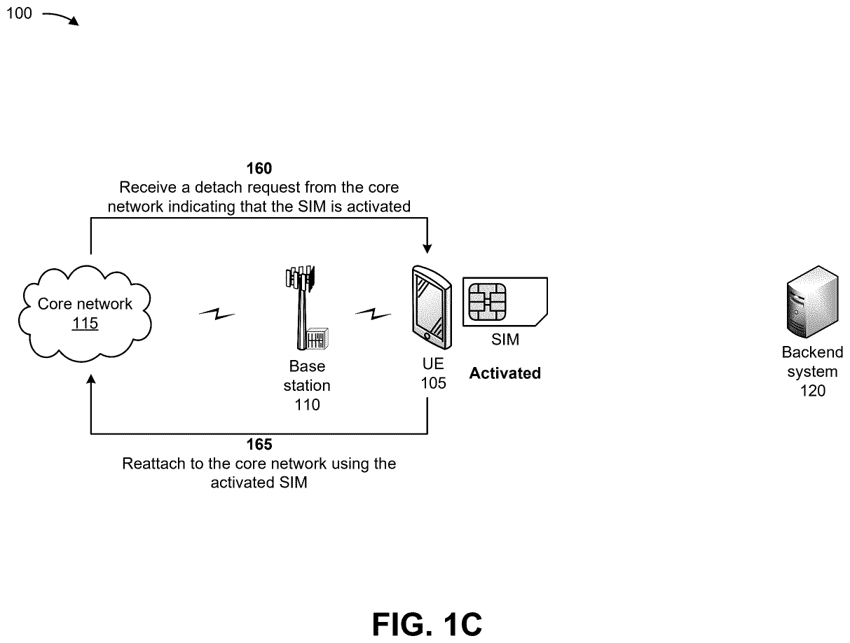

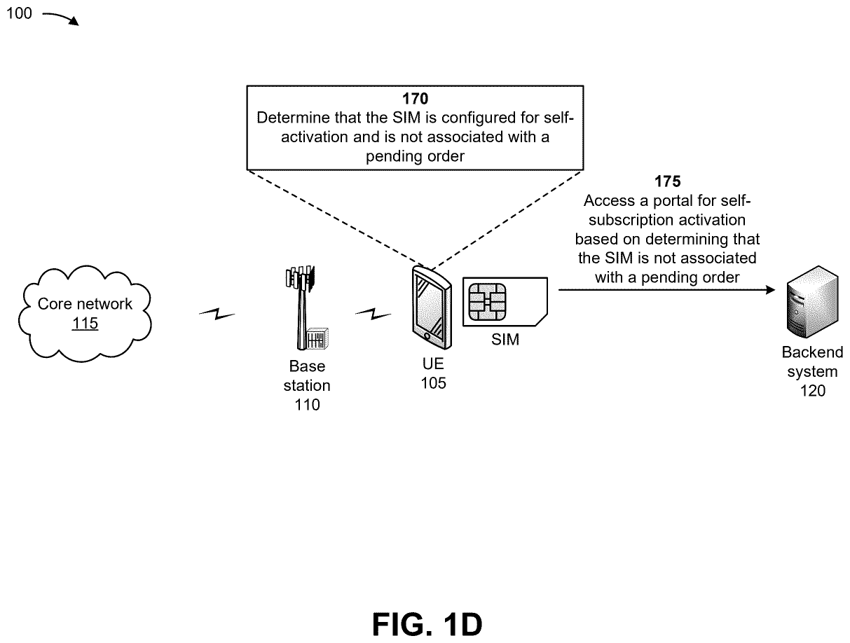

FIGS. 1A-1D are diagrams of an example 100 associated with utilizing PCO container content for UE activation. As shown in FIGS. 1A-1D, the example 100 includes a UE 105 associated with a SIM, a base station 110, a core network 115, and a backend system 120. Further details of the UE 105, the SIM, the base station 110, the core network 115, and the backend system 120 are provided elsewhere herein.

As shown in FIG. 1A, and by reference number 125, the UE 105 may provide a request to attach to the core network 115. For example, the UE 105 may generate a request to attach to a network (e.g., the base station 110 and the core network 115). The UE 105 may provide the request to attach to the base station 110, and the base station 110 may forward the request to the core network 115. In some implementations, the request may enable the UE 105 (e.g., a smartphone or a tablet computer) to begin engagement with the network services provided by the core network 115, and to facilitate the exchange of data and voice services. The request may include an identifier of the UE 105 (e.g., an international mobile subscriber identity (IMSI) or a temporary mobile subscriber identity (TMSI)), which may enable the core network 115 to recognize and authenticate the UE 105. The request may include security information (e.g., encryption keys or authentication tokens) to ensure secure communication between the UE 105 and the core network 115, and details about capabilities of the UE 105 (e.g., supported radio access technologies). The request may also include data identifying a type of service requested by the UE 105 (e.g., data connectivity or voice service), a current location of the UE 105, details about hardware and software of the UE 105, and/or the like.

As further shown in FIG. 1A, and by reference number 130, the UE 105 may receive, from the core network 115, a PCO container that includes an MSISDN. For example, in response to the request to attach, the core network 115 may generate a PCO container. The core network 115 may provide the PCO container to the UE 105, and the UE 105 may receive the PCO container from the core network 115. In some implementations, the PCO container may include a particular identifier number (e.g., “000EH”), and may include vital network setup information for the UE 105, such as subscription identifiers (e.g., the MSISDN). The MSISDN may include one or more predefined prefixes to denote a status of the SIM (e.g., from a network perspective, such as the SIM being eligible for self-activation configuration), a subscription status of the UE 105, and/or the like. In some implementations, the MSISDN may include a predefined prefix indicating that the associated SIM is configured for self-activation, such as starting with a dummy indicator (e.g., “991”).

As further shown in FIG. 1A, and by reference number 135, the UE 105 may determine whether the MSISDN includes a predefined prefix indicative of a subscription status associated with self-activation. For example, the UE 105 may analyze the MSISDN to determine whether the MSISDN includes the predefined prefix indicative of self-activation eligibility for the SIM and the UE 105. In some implementations, if the predefined prefix includes the dummy indicator (e.g., “991”), the UE 105 may determine that the SIM and the UE 105 are associated with a self-activation subscription status. Alternatively, if the predefined prefix fails to include the dummy indicator (e.g., “991”), the UE 105 may determine that the SIM and the UE 105 are not associated with a self-activation subscription status.

As further shown in FIG. 1A, and by reference number 140, the UE 105 may bypass a power-on-activation flow based on determining that the MSISDN does not include the predefined prefix. For example, if the predefined prefix fails to include the dummy indicator (e.g., “991”) and the UE 105 determines that the SIM and the UE 105 are not associated with a self-activation subscription status, the UE 105 may not perform a self-activation procedure, such as a power-on-activation flow, described below in connection with FIG. 1B. In some implementations, the UE 105 may utilize a portal for self-subscription activation (e.g., provided by the backend system 120) to activate the SIM and the UE 105 for utilization of the core network 115.

As shown in FIG. 1B, and by reference number 145, the UE 105 may initiate the power-on-activation flow based on determining that the MSISDN includes the predefined prefix indicative of a subscription status associated with self-activation. For example, if the predefined prefix includes the dummy indicator (e.g., “991”) and the UE 105 determines that the SIM and the UE 105 are associated with a self-activation subscription status, the UE 105 may perform a self-activation procedure, such as the power-on-activation flow. The power-on-activation flow may include the UE 105 checking for pending orders associated with the SIM that need to be executed for activation, and executing activation steps based on the pending orders to configure the SIM for network access. The power-on-activation flow may also include the UE 105 receiving a detach request once the activation of the SIM is complete, and reattaching to the core network 115 using the newly activated SIM (e.g., enabling the SIM and the UE 105 to access network services).

In some implementations, the UE 105 may trigger a self-activation process when the

MSISDN has a prefix indicating a subscription status requiring self-activation. For example, the prefix may cause the UE 105 to retrieve activation parameters from a designated server (e.g., the backend system 120). Additionally, or alternatively, the UE 105 may connect to a subscription management portal for further instructions regarding activation. For example, the UE 105 may access a web-based portal to download initial configuration files or updates required for activation. Additionally, or alternatively, the UE 105 may perform alternative actions such as connecting to a user interface for manual activation input. This approach may be utilized in cases where manual confirmation is preferred for security reasons.

As further shown in FIG. 1B, and by reference number 150, the UE 105 may check for a pending order status associated with the SIM. For example, the UE 105 may provide, to the backend system 120, a query to check for any pending orders associated with the SIM of the UE 105. The query may be part of a signaling process between the UE 105 and the backend system 120, and may request information about any outstanding activation tasks or configurations that need to be applied to the SIM. In some implementations, the backend system 120 may respond to the query with information regarding one or more pending orders associated with the SIM. The response may include details about specific activation steps that need to be executed, such as downloading configuration files, updating subscription information, or applying specific network settings. Alternatively, if there are no pending orders for the SIM, the backend system 120 may respond with information indicating that the SIM is not associated with any pending orders.

In some implementations, rather than checking for pending orders, the UE 105 may automatically perform a default activation sequence in case no specific pending order is identified, thereby ensuring minimal user intervention. Additionally, or alternatively, the UE 105 may receive configuration instructions over-the-air, eliminating the need for a separate query to the backend system 120 for pending orders. Over-the-air updates may be beneficial in reducing latency and improving activation speed.

As further shown in FIG. 1B, and by reference number 155, the UE 105 may execute activation steps for the SIM based on the pending order. For example, if the response to the query includes details about the specific activation steps that need to be executed, the UE 105 may execute the specific activation steps included in the response. In some implementations, the UE 105 may execute scripts or commands that configure the SIM according to requirements of the core network 115. For example, the UE 105 may download configuration files, update subscription information, apply specific network settings, update internal settings, download necessary applications or profiles, adjust connectivity parameters, and/or the like in order to activate the SIM.

As shown in FIG. 1C, and by reference number 160, the UE 105 may receive a detach request from the core network 115 indicating that the SIM is activated. For example, upon successful execution of the activation steps by the UE 105, the core network 115 may provide a detach request to the UE 105, and the UE 105 may receive the detach request from the core network 115. The detach request may serve as an indication that the SIM associated with the UE 105 has been successfully activated in the core network 115 (e.g., in a database of the core network 115). The detach request may be part of a sequence of network commands that facilitate the transition of the SIM to an active state, allowing the UE 105 to fully access network services. The UE 105 may detach from the core network 115 and/or the backend system 120 based on the detach request. Additionally, or alternatively, instead of receiving a detach request, the UE 105 may receive a specific activation confirmation message from the core network 115. The message may include information identifying the successful activation of the SIM and any relevant subscription details or service configurations. Additionally, or alternatively, the core network 115 may provide, to the UE 105, a detach request along with a set of configuration instructions that guide the UE 105 on how to proceed with network service activation. This may include instructions for updating network settings or initiating specific protocols for enhanced service access.

As further shown in FIG. 1C, and by reference number 165, the UE 105 may reattach to the core network 115 using the activated SIM. For example, after detaching from the core network 115, the UE 105 may initiate a reattach process with the core network 115, utilizing the now-activated SIM. The reattach process may include the UE 105 providing a new attach request to the core network 115 to re-establish network connectivity under the activated SIM status. The reattach operation may ensure that the UE 105 may seamlessly access network services like data connectivity and voice calls, and may utilize the activated SIM configuration.

Alternatively, the UE 105 may perform a full network reset upon receiving the activation confirmation via the detach request. The network reset may include erasing any previous network configurations and starting a fresh network initialization using the activated SIM parameters. Additionally, or alternatively, the reattach process may include a series of verification steps where the UE 105 confirms the activation status with the network 115 before full access is granted. These steps may include validating the SIM credentials or performing a security handshake. Additionally, or alternatively, instead of reattaching immediately, the UE 105 may temporarily enter a standby mode, during which the UE 105 prepares necessary system updates or optimizations in response to the SIM activation. Once ready, the UE 105 may proceed with reattaching to the network.

As shown in FIG. 1D, and by reference number 170, the UE 105 may determine that the SIM is configured for self-activation and is not associated with a pending order. For example, the backend system 120 may provide, to the UE 105, a message indicating that the SIM is not associated with a pending order for self-activation. The UE 105 may utilize the MSISDN received in the PCO container to determine a status of the SIM. The determination may involve analyzing the MSISDN for a predefined prefix, which indicates that the SIM is not yet fully activated and is eligible for self-activation. The absence of any pending orders associated with the SIM may indicate that the SIM activation is self-managed and not awaiting network-based tasks. Thus, the UE 105 and the backend system 120 may not perform a self-activation process for the SIM based on the lack of a pending order.

As further shown in FIG. 1D, and by reference number 175, the UE 105 may access a portal for self-subscription activation based on determining that the SIM is not associated with a pending order. For example, when the UE 105 determines that the SIM is not associated with a pending order, the UE 105 may initiate a connection to a backend system 120, which may host a subscription management portal. The subscription management portal provides the resources and interfaces for the UE 105 to complete the self-activation process for the SIM. The UE 105 may access this portal using network connectivity facilitated by the core network 115 and the base station 110. Through the portal, a user of the UE 105 may select subscription plans, enter personal information, and finalize the activation of the SIM to enable full network service access.

Additionally, or alternatively, the UE 105 may display a local interface allowing the user to initiate self-activation steps without requiring immediate network connectivity if such connectivity is not readily available. Additionally, or alternatively, in addition to selecting subscription plans, the user may be prompted to verify an identity through multi-factor authentication processes facilitated by the portal.

In this way, implementations described herein utilize PCO container content for UE activation. For example, the implementations may transition from operator-reserved PCO containers, which may be decommissioned, to a standardized PCO container. The standardized PCO container may include MSISDN prefixes to indicate subscription statuses and to minimize network resource consumption during subscription management processes. By reducing the network impact and optimizing the activation flow, the implementations may prevent inefficient subscription handling, redundant activation attempts, and the use of non-standardized container formats. Thus, the implementations may conserve computing resources, networking resources, and/or other resources that would have otherwise been consumed by failing to provide a mechanism that guides UE behavior during SIM activation, failing to provide a mechanism that provides UE and SIM self-activation, providing a poor user experience associated with UE activation, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

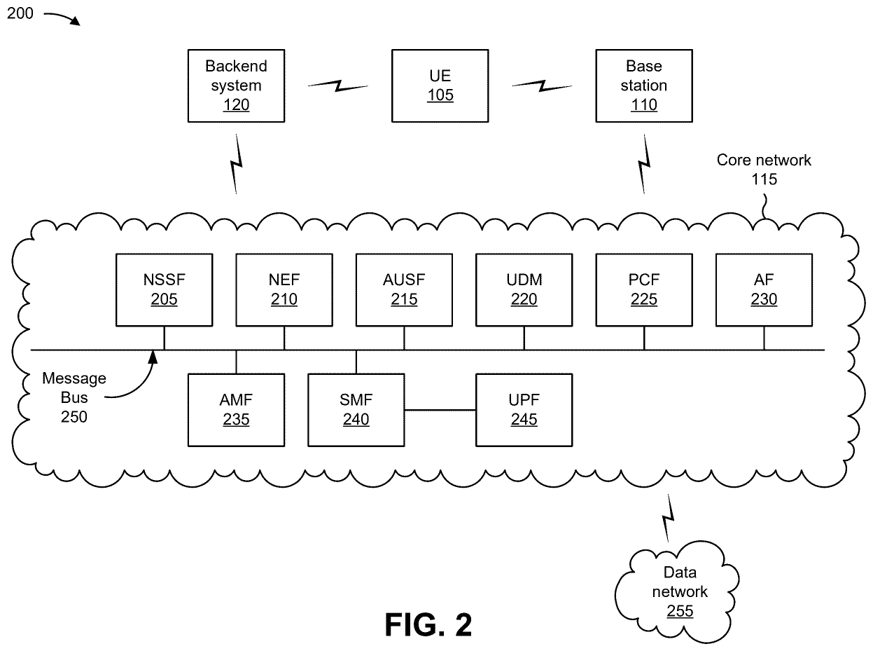

FIG. 2 is a diagram of an example environment 200 in which systems and/or methods described herein may be implemented. As shown in FIG. 2, the example environment 200 may include the UE 105, the base station 110, the core network 115, the backend system 120, and a data network 255. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

The backend system 120 may include one or more devices capable of receiving, generating, storing, processing, providing, and/or routing information, as described elsewhere herein. The backend system 120 may include a communication device and/or a computing device. For example, the backend system 120 may include a server, such as an application server, a client server, a web server, a database server, a host server, a proxy server, a virtual server (e.g., executing on computing hardware), or a server in a cloud computing system. In some implementations, the backend system 120 may include computing hardware used in a cloud computing environment, such as one or more serverless components (e.g., one or more serverless functions).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a fourth generation (4G) core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, and/or a user plane function (UPF) 245. These functional elements may be communicatively connected via a message bus 250. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The message bus 250 represents a communication structure for communication among the functional elements. In other words, the message bus 250 may permit communication between two or more functional elements.

The data network 255 includes one or more wired and/or wireless data networks. For example, the data network 255 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

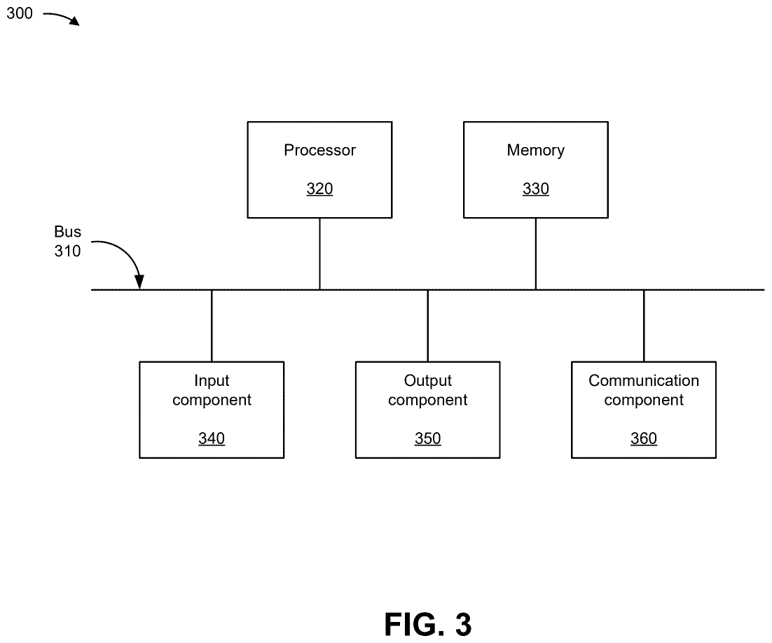

FIG. 3 is a diagram of example components of a device 300, which may correspond to the UE 105, the base station 110, the NSSF 205, the NEF 210, the AUSF 215, the UDM 220, the PCF 225, the AF 230, the AMF 235, the SMF 240, and/or the UPF 245. In some implementations, the UE 105, the base station 110, the NSSF 205, the NEF 210, the AUSF 215, the UDM 220, the PCF 225, the AF 230, the AMF 235, the SMF 240, and/or the UPF 245 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

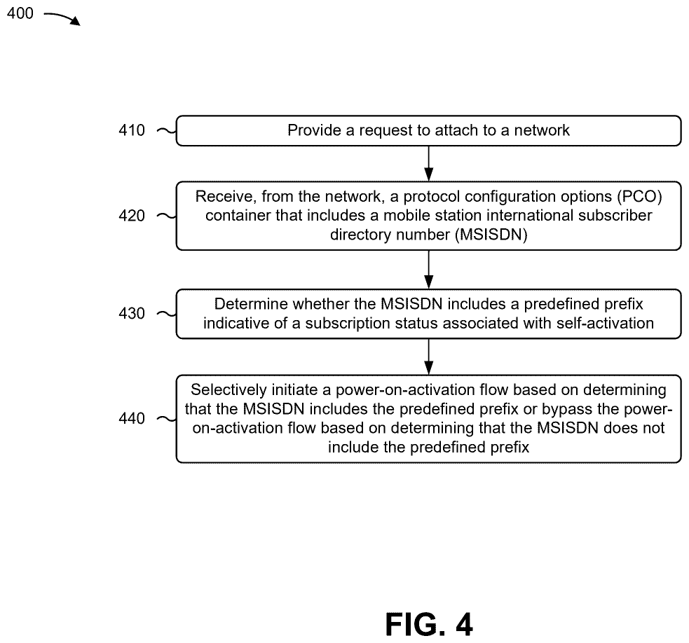

FIG. 4 is a flowchart of an example process 400 for utilizing PCO container content for UE activation. In some implementations, one or more process blocks of FIG. 4 may be performed by a device (e.g., the UE 105) SMF 240 and/or the UPF 245). In some implementations, one or more process blocks of FIG. 4 may be performed by a network device or a group of network devices separate from or including the device, such as an SMF (e.g., the SMF 240), a UPF (e.g., the UPF 245), an AMF (e.g., the AMF 235), an AUSF (e.g., the AUSF 215), a UDM (e.g., the UDM 220), and/or the like. In a 4G context, one or more process blocks of FIG. 4 may be performed by a packet data network gateway (PGW), a mobility management entity (MME), and/or a home subscriber server (HSS). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include providing a request to attach to a network (block 410). For example, the UE may provide a request to attach to a network, as described above.

As further shown in FIG. 4, process 400 may include receiving, from the network, a PCO container that includes an MSISDN (block 420). For example, the UE may receive, from the network, a PCO container that includes an MSISDN, as described above. In some implementations, the PCO container includes an identifier number of 000EH.

As further shown in FIG. 4, process 400 may include determining whether the MSISDN includes a predefined prefix indicative of a subscription status associated with self-activation (block 430). For example, the UE may determine whether the MSISDN includes a predefined prefix indicative of a subscription status associated with self-activation, as described above. In some implementations, the predefined prefix includes a unique numerical sequence associated with non-active SIM cards. In some implementations, the predefined prefix is configurable by an operator of the network.

As further shown in FIG. 4, process 400 may include selectively initiating a power-on-activation flow based on determining that the MSISDN includes the predefined prefix, or bypassing the power-on-activation flow based on determining that the MSISDN does not include the predefined prefix (block 440). For example, the UE may selectively initiate a power-on-activation flow based on determining that the MSISDN includes the predefined prefix, or bypass the power-on-activation flow based on determining that the MSISDN does not include the predefined prefix, as described above. In some implementations, initiating the power-on-activation flow includes activating a SIM of the UE based on a pending order. In some implementations, initiating the power-on-activation flow includes determining that a SIM of the UE is configured for self-activation and is not associated with a pending order, and redirecting the UE to a portal for self-subscription activation based on determining that the SIM is not associated with a pending order.

In some implementations, process 400 includes determining, based on determining that the MSISDN includes the predefined prefix, that a SIM of the UE is configured for self-activation. In some implementations, process 400 includes checking for a pending order associated with the SIM based on determining that the SIM is configured for self-activation, and executing one or more activation steps for the SIM based on the pending order associated with the SIM. In some implementations, process 400 includes receiving a detach request from the network indicating that the SIM is an activated SIM based on executing the one or more activation steps, and reattaching to the network using the activated SIM.

In some implementations, process 400 includes triggering a self-activation process based on determining that the MSISDN includes the predefined prefix. In some implementations, process 400 includes accessing a portal for subscription management based on initiating the power-on-activation flow. In some implementations, process 400 includes receiving network instructions to perform the power-on-activation flow based on determining that the MSISDN includes the predefined prefix. In some implementations, process 400 includes performing one or more actions based on initiating the power-on-activation flow.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination. As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
providing, by a user equipment, a request to attach to a network;
receiving, by the user equipment, a protocol configuration option (PCO) container that includes a mobile station international subscriber directory number (MSISDN);
determining, by the user equipment, whether the MSISDN includes a predefined prefix indicative of a subscription status; and
selectively:
initiating, by the user equipment, a power-on-activation flow based on determining that the MSISDN includes the predefined prefix, or
bypassing, by the user equipment, the power-on-activation flow based on determining that the MSISDN does not include the predefined prefix.

2. The method of claim 1, further comprising:
determining, when the MSISDN includes the predefined prefix, that a subscriber identity module (SIM) of the user equipment is configured for self-activation.

3. The method of claim 2, further comprising:
checking for a pending order associated with the SIM based on determining that the SIM is configured for self-activation; and
executing one or more activation steps for the SIM based on the pending order associated with the SIM.

4. The method of claim 3, further comprising:
receiving a detach request from the network indicating that the SIM is an activated SIM based on executing the one or more activation steps; and
reattaching to the network using the activated SIM.

5. The method of claim 1, wherein the PCO container includes an identifier number of 000EH.

6. The method of claim 1, wherein the predefined prefix includes a unique numerical sequence associated with non-active SIM cards.

7. The method of claim 1, further comprising:
triggering a self-activation process based on determining that the MSISDN includes the predefined prefix.

8. A user equipment, comprising:
one or more processors configured to:
provide a request to attach to a network;
receive, from the network, a protocol configuration options (PCO) container that includes a mobile station international subscriber directory number (MSISDN);
determine whether the MSISDN includes a predefined prefix indicative of a subscription status,
wherein the predefined prefix includes a unique numerical sequence associated with non-active SIM cards; and
selectively:
initiate a power-on-activation flow based on determining that the MSISDN includes the predefined prefix, or
bypass the power-on-activation flow based on determining that the MSISDN does not include the predefined prefix.

9. The user equipment of claim 8, wherein the one or more processors are further configured to:
access a portal for subscription management based on initiating the power-on-activation flow.

10. The user equipment of claim 8, wherein the one or more processors, to initiate the power-on-activation flow, are configured to:
activate a subscriber identity module (SIM) of the user equipment based on a pending order.

11. The user equipment of claim 8, wherein the one or more processors are further configured to:
receive network instructions to perform the power-on-activation flow based on determining that the MSISDN includes the predefined prefix.

12. The user equipment of claim 8, wherein the predefined prefix is configurable by an operator of the network.

13. The user equipment of claim 8, wherein the one or more processors are further configured to:
perform one or more actions based on initiating the power-on-activation flow.

14. The user equipment of claim 8, wherein the one or more processors, to initiate the power-on-activation flow, are configured to:
determine that a subscriber identity module (SIM) of the user equipment is configured for self-activation and is not associated with a pending order; and
redirect the user equipment to a portal for self-activation based on determining that the SIM is not associated with a pending order.

15. A non-transitory computer-readable medium storing a set of instructions, the set of instructions comprising:
one or more instructions that, when executed by one or more processors of a user equipment, cause the user equipment to:
provide a request to attach to a network;
receive, from the network, a protocol configuration options (PCO) container that includes a mobile station international subscriber directory number (MSISDN);
determine whether the MSISDN includes a predefined prefix indicative of a subscription status associated with self-activation;
initiate a power-on-activation flow based on determining that the MSISDN includes the predefined prefix; and
determine that a subscriber identity module (SIM) of the user equipment is configured for self-activation based on initiating the power-on-activation flow.

16. The non-transitory computer-readable medium of claim 15, wherein the one or more instructions further cause the user equipment to:
check for a pending order associated with the SIM based on determining that the SIM is configured for self-activation; and
execute one or more activation steps for the SIM based on the pending order associated with the SIM.

17. The non-transitory computer-readable medium of claim 16, wherein the one or more instructions further cause the user equipment to:
receive a detach request from the network indicating that the SIM is an activated SIM based on executing the one or more activation steps; and
reattach to the network using the activated SIM.

18. The non-transitory computer-readable medium of claim 15, wherein the predefined prefix includes a unique numerical sequence associated with non-active SIM cards.

19. The non-transitory computer-readable medium of claim 15, wherein the one or more instructions further cause the user equipment to:
access a portal for subscription management based on initiating the power-on-activation flow.

20. The non-transitory computer-readable medium of claim 15, wherein the one or more instructions further cause the user equipment to:
perform one or more actions based on initiating the power-on-activation flow.
